(19) United States
(12) Patent Application Publication
(10) Pub. No.: US 2013/0340546 A1
(43) Pub. Date: Dec. 26, 2013

(54) TRANSMISSION MECHANISM AND PRINTER WITH TRANSMISSION MECHANISM

(71) Applicant: HON HAI PRECISION INDUSTRY CO., LTD., New Taipei (TW)

(72) Inventor: Chi-Jung TSAI, New Taipei (TW)

(73) Assignee: HON HAI PRECISION INDUSTRY CO., LTD., New Taipei (TW)

(21) Appl. No.: 13/848,581

(22) Filed: Mar. 21, 2013

(30) Foreign Application Priority Data
Jun. 21, 2012 (TW) 101122314

(51) Int. Cl. F16H 19/04

(52) U.S. Cl. CPC F16H 19/04
USPC 74/30

(57) ABSTRACT

A transmission mechanism includes a guide rod, a gear assembly meshed with the guide rod, a blocking member attached to the guide rod, and a resilient member. The resilient member surrounds the guide rod. A first end of the resilient member abuts the blocking member, and a second end opposite to the first end is configured to abut a printer. The resilient member drives the guide rod to rotate the gear assembly.

### BACKGROUND 1. Technical Field

The present disclosure relates to printers, and particularly to an printer with a transmission mechanism. 2. Description of Related Art

Printer may include a door for covering ink cartridge. Some times when printing, the printer may jam. To remove the jammed paper, the door has to be opened manually, which is very inconvenient. Furthermore, when the ink cartridge is empty and needs to be replaced, the door has to be opened manually which it not convenient. Therefore, there is room for improvement within the art.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an exploded, isometric view of an embodiment of an printer.

FIG. 2 is similar to FIG. 1, but viewed from a different aspect.

FIG. 3 is an enlarged view of the circled portion III of FIG. 2.

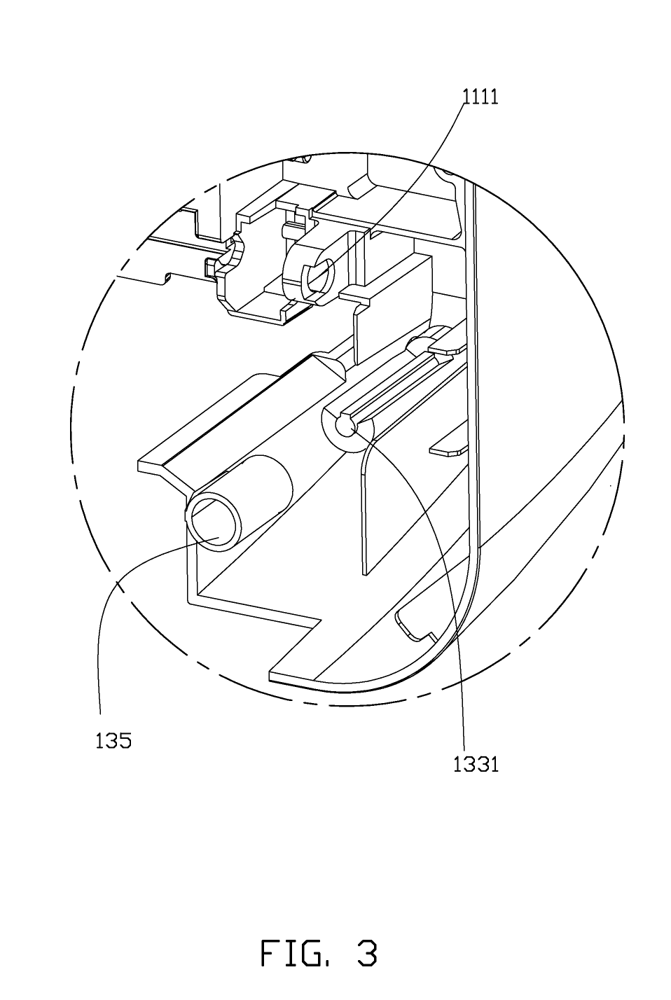

FIG. 4 is an exploded, isometric view of a transmission mechanism of FIG. 1.

FIG. 5 is an assembled view of the transmission mechanism of FIG. 4.

FIG. 6 is assembled view of the printer of FIG. 1, but the door is closed.

FIG. 7 is similar to FIG. 6, but viewed from a different aspect.

FIG. 8 is similar to FIG. 6, but the door is opened.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

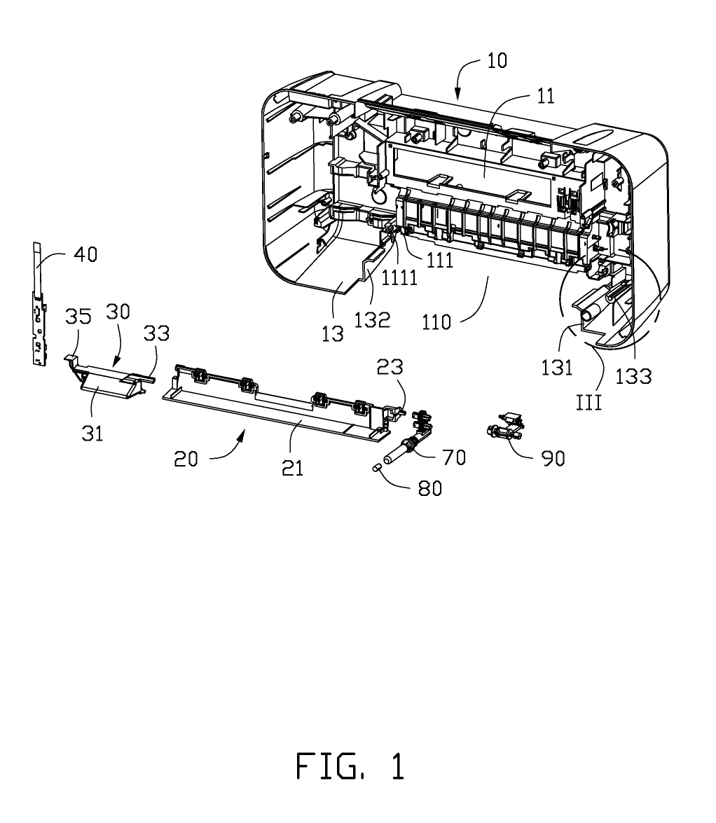

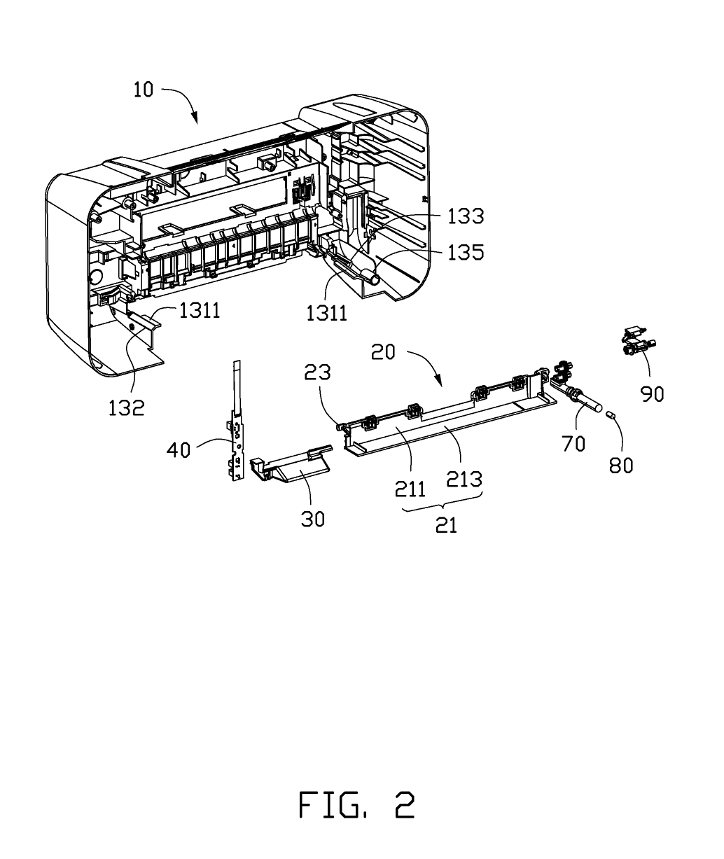

FIGS. 1 and 2 illustrate a printer in accordance with an embodiment. The printer includes a lid 10, a door 20 rotatably secured to the lid 10, a sensor 30, a circuit board 40 attached to the lid 10, a transmission mechanism 70, a motivating member 80 located on one side of the lid 10, and a wiper 90. In one embodiment, the motivating member 80 may be a scanning module, for example.

The lid 10 includes a top plate 11 and two side boards 13 extending from one side of the top plate 11. The top plate 11 and the two side boards 13 cooperatively define an opening 110 so as to allow ink cartridges to be inserted into and withdrawn from the opening 110. Two rotating tabs 111 extend outwards from the top plate 11 and located above the opening 110. Each of the two rotating tabs 111 defines a rotating hole 1111 for receiving the door 20. A positioning tab 113 extends outwards from the top plate 11 adjacent to one of the two rotating tabs 111. A positioning hole 1131 is defined in the positioning tab 113.

A first flange 131 and a second flange 132 extends upwards from edges of the two side boards 13, positioned below the two rotating tabs 111. Two blocking tabs 1311 extend towards each other from upper edges of the first flange 131 and the second flange 132, respectively. An elongated receiving portion 133 is positioned on the first flange 131 and below the positioning tab 113. A receiving slot 1331 along the first flange 131 is defined in the receiving portion 133. A sleeve 135 is positioned on the first flange 131 and in front of the receiving portion 133.

The door 20, is configured to cover or uncover the opening 110, includes a door body 21 and two rotating posts 23 positioned on the door body 21. The door body 21 includes a first board 211 and a second board 213 connected to the first board 211. In one embodiment, the door body 21 is substantially L-shaped. The first board 211 is substantially perpendicular to the second board 213. The two rotating posts 23 are positioned on opposite ends of the first board 211 and are configured to be received in the rotating hole 1111 of the two rotating tabs 111, to secure the door 20 to the lid 10.

The sensor 30, is rotatably attached to the second flange 132 and includes a sway portion 31, a resisting tab 33, and a touching portion 35. The resisting tab 33 and the touching portion 35 are positioned on two opposite ends of the sway portion 31. The resisting tab 33 is capable of touching the door 20. The touching portion 35 is electrically connected to the circuit board 40.

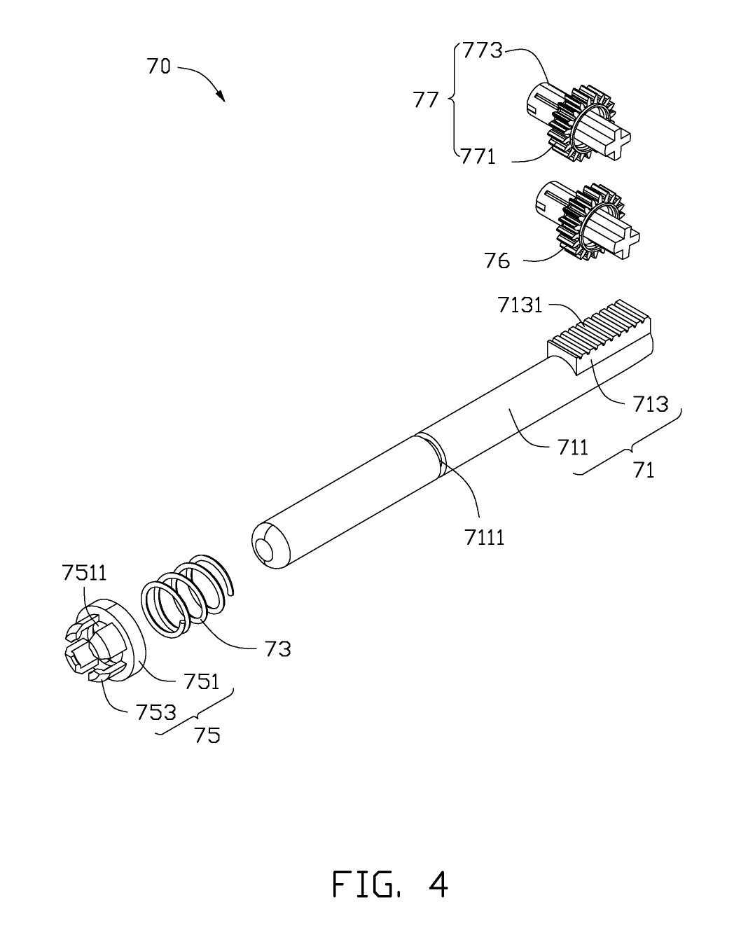

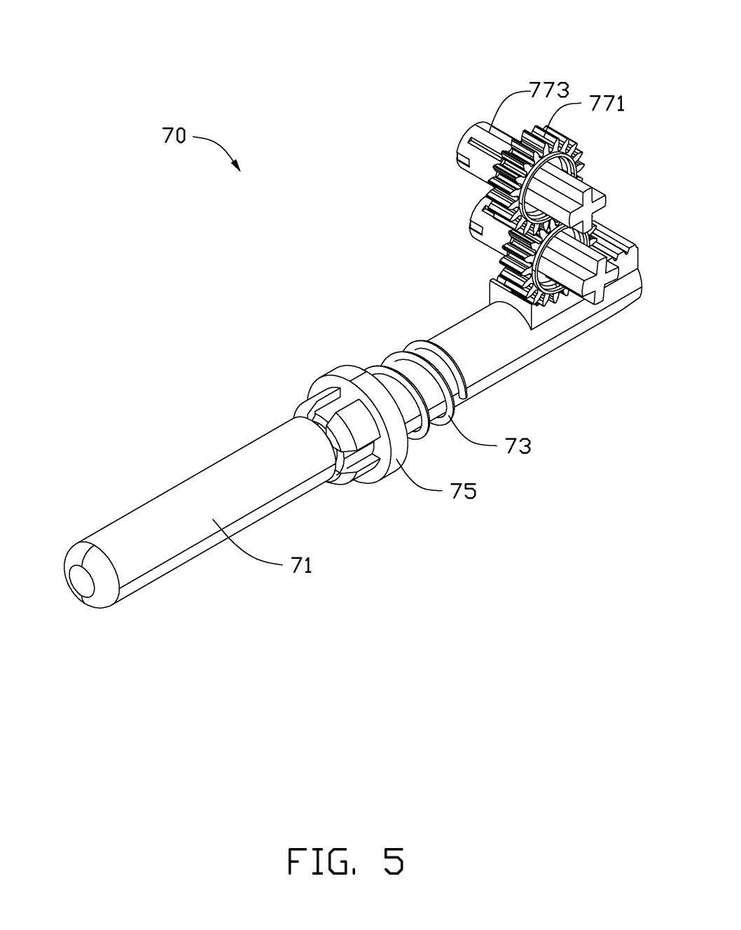

FIGS. 4 and 5 show that the transmission mechanism 70 includes an elongated guide rod 71, a resilient member 73, a blocking member 75, a first gear assembly 76, and a second gear assembly 77. In one embodiment, the resilient member 73 is a compression spring. The guide rod 71 includes a guide rod body 711 and a protruding portion 713, located on one end of the guide rod body 711. The guide rod body 711 defines a circular groove 7111 in the middle of the guide rod body 711. A plurality of racks 7131 is positioned on a surface of the protruding portion 713. The blocking member 75 includes a ring 751 and a plurality of latch tabs 753 positioned on the ring 751. The ring 751 surrounds the guide rod body 711, and the plurality of the latch tabs 753 are engaged in the groove 7111, to secure the blocking member 75 to the guide rod 71. Each of the first gear assembly 76 and the second gear assembly 77 includes a shaft 771 and a gear 773 surrounding the shaft 771.

The wiper 90 is configured to wipe a nozzle (not shown) of the printer, and is rotatably secured to the lid 10 and adjacent to an upper right of the receiving portion 133.

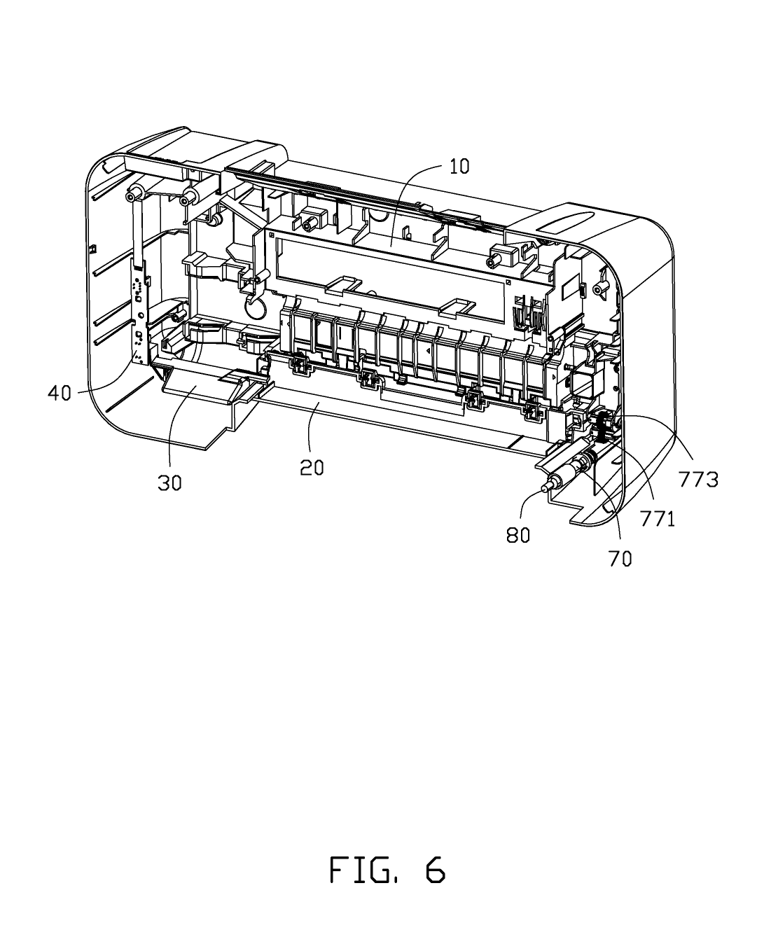

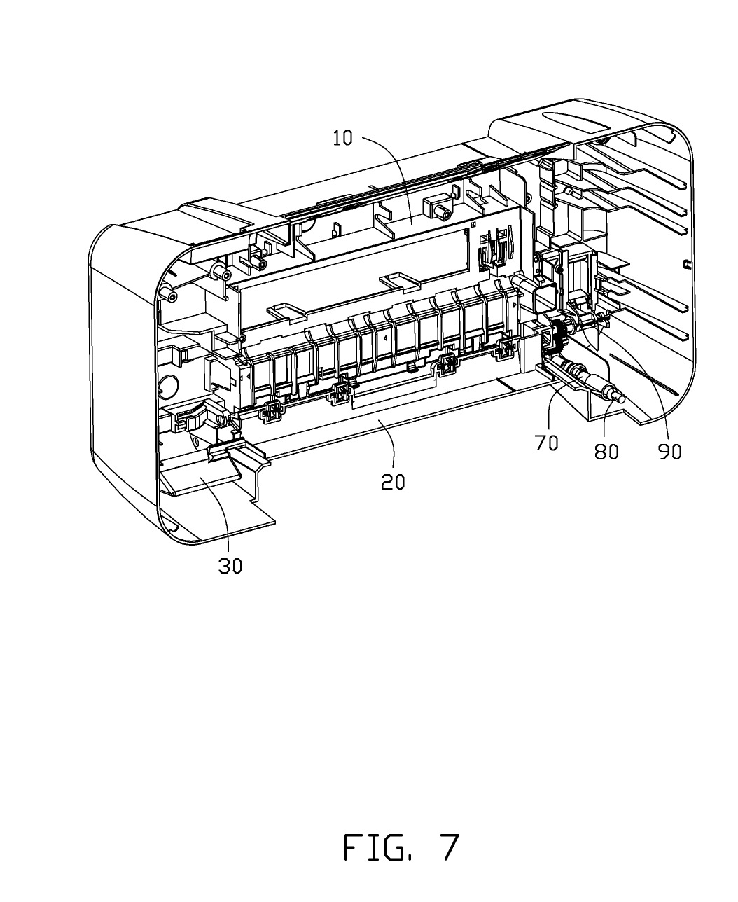

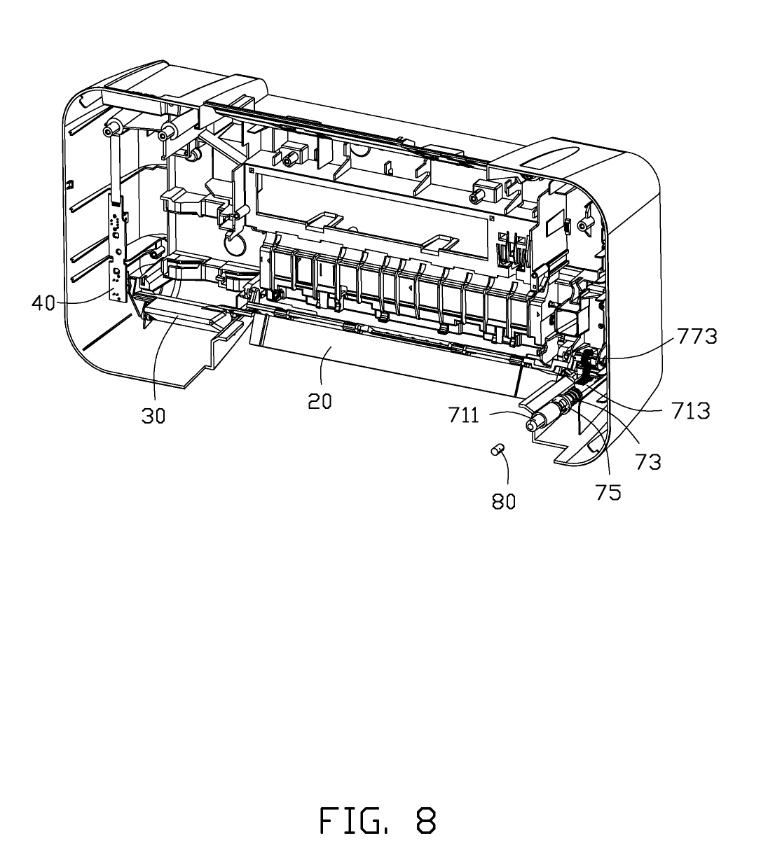

FIGS. 6-8 show that in assembly, each of the two rotating posts 23 is received in the rotating hole 1111 of each of the two rotating tabs 111, rotatably securing the door 20 to the lid 10.

The resilient member 73 surrounds the guide rod body 711. The ring 751 of the blocking member 75 surrounds the guide rod body 711, and the plurality of latch tabs 753 are engaged in the groove 7111, to secure the blocking member 75 to the guide rod 71. A part of the guide rod 71 is accommodated in the receiving slot 1331 and partly extends through the sleeve 135 to abut the motivating member 80. The protruding portion 713 is adjacent to the top plate 11. Thus, the resilient member 73 is sandwiched between the ring 751 of the blocking member 75 and the receiving portion 133. One end of the shaft 771 of the first gear assembly 76 is engaged in the positioning hole 1131 of the lid 10. One end of the shaft 771 of the second gear assembly 77 is engaged with one of the two rotating posts 23, and another end of the shaft 771 of the second gear assembly 77 is engaged with the wiper 90. The gear 773 of the first gear assembly 76 is meshed with the gear 773 of the second gear assembly 77 and the plurality of racks 7131 of the guide rod 71.

In use, the motivating member 80 squeezes the guide rod 71 to slide along a first direction which is close to the top plate 11. The resilient member 73 is resiliently deformed, and the plurality of racks 7131 drives the first gear assembly 76 to rotate. The rotation of the first gear assembly 76 drives the second gear assembly 77 to rotate. The second gear assembly 77 rotates the door 20 to be opened and cover the opening 110, and rotates the wiper 90 to disengage from the nozzle.

When ink cartridges need to be replaced or paper jams need to be removed, the motivating member 80 is lift up, and the resilient member 73 rebounds to drive the guide rod 71 to slid along a second direction opposite to the first direction. The plurality of racks 7131 drives the first gear assembly 76 to rotate. The rotation of the first gear assembly 76 drives the second gear assembly 77 to rotate. The second gear assembly 77 rotates the door 20 to be closed and uncover the opening 110. The rotation of the door 20 rotates the sensor 30 to the touching portion 35 to touch the circuit board 40. The circuit board 40 applies signals to a central processing unit of the printer. The central processing unit stops ink cartridges from moving, to prevent hands from being pinched.

It is to be understood, however, that even though numerous characteristics and advantages have been set forth in the foregoing description of embodiments, together with details of the structures and functions of the embodiments, the disclosure is illustrative only and changes may be made in detail, especially in the matters of shape, size, and arrangement of parts within the principles of the disclosure to the full extent indicated by the broad general meaning of the terms in which the appended claims are expressed.

What is claimed is:

1. A transmission mechanism comprising:
a guide rod;
a gear assembly meshed with the guide rod;
a blocking member attached to the guide rod; and
a resilient member surrounding the guide rod, a first end of the resilient member abutting the blocking member, and a second end opposite to the first end configured to abut a printer,
wherein the guide rod is movable to rotate the gear assembly by the resilient member.

2. The transmission mechanism of claim 1, wherein the guide rod comprises a guide rod body, the blocking member comprises a ring, and the ring surrounds the guide rod body.

3. The transmission mechanism of claim 2, wherein the first end of the resilient member abuts the ring.

4. The transmission mechanism of claim 2, wherein the guide rod body defines a circular groove in the middle of the guide rod, the blocking member comprises a plurality of latch tabs located on the ring, and the plurality of latch tabs are engaged in the circular groove.

5. The transmission mechanism of claim 2, wherein the guide rod further comprises a protruding portion located on the guide rod body, and the gear assembly is meshed with the protruding portion.

6. The transmission mechanism of claim 5, wherein a plurality of racks are located on the protruding portion, the gear assembly comprises a gear, and the plurality of racks are meshed with the gear.

7. A printer comprising:
a lid defining an opening and comprising a receiving portion located on one side of the opening, the receiving portion defining a receiving slot;
a door rotatably secured to the lid for cover the opening;
a guide rod partly received in the receiving slot;
at least one gear assembly secured to the lid and meshed with the guide rod, the at least one gear assembly being engaged with the door;
a blocking member secured to the guide rod; and
a resilient member surrounding the guide rod and located between the blocking member and the receiving portion,
wherein the guide rod is movable along a first direction to rotate the gear assembly driven by the resilient member, and the at least one gear assembly rotates the door relative to the lid, to open the door.

8. The printer of claim 7, further comprises a motivating member located on one side of the lid, wherein the guide rod is movable along a second direction opposite to the first direction driven by the motivating member, and the at least one gear assembly rotates the door relative to the lid, to close the door.

9. The printer of claim 7, wherein the guide rod comprises a guide rod body, the blocking member comprises a ring, and the ring surrounds the guide rod body.

10. The printer of claim 9, wherein a first end of the resilient member abuts the ring, and a second end of the resilient member abuts the receiving portion.

11. The printer of claim 9, wherein the guide rod body defines a circular groove in the middle of the guide rod, the blocking member comprises a plurality of latch tabs located on the ring, and the plurality of latch tabs are engaged in the circular groove.

12. The printer of claim 9, wherein the guide rod further comprises a plurality of racks, the at least one gear assembly comprises a first gear assembly, and the plurality of racks are meshed with the first gear assembly.

13. The printer of claim 12, wherein the guide rod further comprises a protruding portion, and the plurality of racks are located on a surface of the protruding portion.

14. The printer of claim 12, wherein the at least one gear assembly further comprise a second gear assembly meshed with the first gear assembly, the door comprises two rotating posts engaged in the lid, and one of the two rotating posts is engaged with the second gear assembly.

15. The printer of claim 7, further comprising a sensor and a circuit board, the door is capable of touching with the door, and the sensor is electrically connected to the circuit board.

16. The printer of claim 7, wherein a sleeve is located on a side wall of the opening and in front of the receiving portion, and the guide rod partly extends through the sleeve to abut the motivating member.

17. The printer of claim 7, wherein the resilient member is a compression spring.
